(19) United States
(12) Patent Application Publication
(10) Pub. No.: US 2022/0246909 A1
(43) Pub. Date: Aug. 4, 2022

(54) LITHIUM METAL ANODE AND METHOD FOR MAKING THE SAME

(71) Applicants: Tsinghua University, Beijing (CN); HON HAI PRECISION INDUSTRY CO., LTD., New Taipei (TW)

(72) Inventors: JING WANG, Beijing (CN); JIA-PING WANG, Beijing (CN); SHOU-SHAN FAN, Beijing (CN)

(21) Appl. No.: 17/392,572

(22) Filed: Aug. 3, 2021

(30) Foreign Application Priority Data
Jan. 29, 2021 (CN) 202110123588.X

(51) Int. Cl. H01M 4/1395; H01M 4/134; H01M 4/38; H01M 4/66; H01M 4/80; H01M 4/62; H01M 10/052

(52) U.S. Cl. CPC H01M 4/1395; H01M 4/134; H01M 4/382; H01M 2004/027; H01M 4/808; H01M 4/62; H01M 10/052; H01M 4/663

(57) ABSTRACT

A method of making a lithium metal anode, comprises: S1, preparing a carbon nanotube material; S2, adding the carbon nanotube material to an organic solvent, and ultrasonically agitating the organic solvent with the carbon nanotube material to form a flocculent structure; S3, rinsing the flocculent structure with water; S4, freeze-drying the flocculent structure in vacuum environment to obtain a carbon nanotube sponge preform; S5, depositing a carbon layer on the carbon nanotube sponge preform to form a carbon nanotube sponge: and S6, injecting molten lithium into the carbon nanotube sponge in an oxygen-free environment, and cooling the molten lithium and the carbon nanotube sponge to form a lithium metal anode.

### CROSS-REFERENCE TO RELATED APPLICATIONS

This application claims all benefits accruing under 35 U.S.C. § 119 from China Patent Application No. 202110123588.X, filed on Jan. 29, 2021, in the China National Intellectual Property Administration, the contents of which are hereby incorporated by reference.

### FIELD

The present disclosure relates to a lithium metal anode and method for making the same.

### BACKGROUND

Lithium ion batteries are widely used in electric vehicles, portable electronic devices, etc. Anode electrodes of conventional lithium ion batteries are made of graphite with a theoretical capacity of 372 mAhg⁻¹, which cannot meet the growing demand for higher lithium ion battery capacities. Since a lithium metal anode has a high theoretical capacity of 3860 mAh g⁻¹ and a low redox potential of −3.04V, the lithium metal anode is considered to be a “Holy Grail” electrode of next generation rechargeable batteries.

However, a conventional lithium metal anode has some characters which may hinder its practical application. A deposition of lithium in the cycle is uneven during the cycling, and a uneven deposition will lead to the growth of lithium dendrites. A chemical reaction between lithium and liquid electrolyte results in a solid electrolyte interface (SEI) on a surface of a lithium metal. Lithium dendrites can penetrate the SEI, and exposing lithium under the SEI to react with the liquid electrolyte, leading to a electrolyte consumption and side reaction. When the dendrites are too long, the lithium dendrites will break and lose connection with the lithium metal anode. which results in “dead” lithium. A structure of the lithium metal anode will lose volume and change shapes as the SEI forms and lithium dendrites grows. These problems eventually lead to capacity loss, lower coulomb efficiency and higher risk of battery failure over time. Therefore, reducing lithium dendrites and improving the coulombic efficiency and volume effect of lithium anodes may be desirable to promote industrialization of lithium anodes or lithium metal batteries.

### BRIEF DESCRIPTION OF THE DRAWINGS

Implementations of the present technology will now be described, by way of example only, with reference to the attached figures.

FIG. 1 is a flowchart of a method of making a lithium metal anode according to the present disclosure.

FIG. 2 is a scanning electron microscope (SEM) of one embodiment of the lithium metal anode according to the present disclosure.

FIG. 3 is a schematic view and a cross-sectional view of one embodiment of the lithium metal anode according to the present disclosure.

FIG. 4 is an enlarged schematic view of a local structure of a carbon nanotube sponge.

FIG. 5 a schematic view of one embodiment of a structure of a lithium ion battery according to the present disclosure.

FIG. 6A is a transmission electron microscope (TEM) image of the carbon nanotube sponge preform of Comparative Example 1.

FIG. 6B is the TEM image of the carbon nanotube sponge of Example 1 of the present disclosure.

FIG. 7A is a SEM image of the carbon nanotube sponge preform of Comparative Example 1.

FIG. 7B is the SEM image of the carbon nanotube sponge of Example 1.

FIG. 8 is Raman spectra of the carbon nanotube sponge preform of Comparative Example 1 and the carbon nanotube sponge of Example 1.

FIG. 9 is a Brunauer Emmett Teller (BET) side view of the carbon nanotube sponge preform of Comparative Example 1 and the carbon nanotube sponge of Example 1.

FIG. 10 is a pore size distribution diagram of the carbon nanotube sponge preform of Comparative Example 1 and the carbon nanotube sponge of Example 1.

FIG. 11A is a pressure test process diagram of the carbon nanotube sponge preform of Example 1.

FIG. 11B is the pressure test process diagram of the carbon nanotube sponge of Example 1.

FIG. 12A is a structure comparison diagram before and after adding an electrolyte to the carbon nanotube sponge preform of Comparative Example 1.

FIG. 12B is the structure comparison diagram before and after adding an electrolyte to the carbon nanotube sponge of Example 1.

FIG. 13 is a process diagram of thermally infusing a molten lithium into carbon nanotube sponge of Example 1.

FIG. 14A is a lithium wettability test of the carbon nanotube sponge of Example 1.

FIG. 14B is the lithium wettability test of the carbon nanotube sponge preform of Comparative Example 1.

FIG. 14C is the lithium wettability test of a amorphous carbon coated stainless steel.

FIG. 14D is the lithium wettability test of an original stainless steel.

FIG. 15 is a X-Ray Photoelectron Spectroscopy (XPS) spectrum of the lithium metal anode of Example 1.

FIG. 16 is a voltage-time graph of a symmetrical battery using the bare lithium metal electrode of Comparative Example 2.

FIG. 17 is a voltage-time graph of a symmetrical battery using the lithium metal anode of Example 2.

FIG. 18 is a voltage-time graph of the symmetrical battery of the bare lithium metal electrode of Comparative Example 2 and the lithium metal anode of Example 2 during a cycle time of 78-80 hours.

FIG. 19 is the voltage-time graph of the symmetrical battery using the bare lithium metal electrode of Comparative Example 2.

FIG. 20 is the voltage-time graph of the symmetrical battery using the lithium metal anode of Example 2.

FIG. 21 is Nyquist diagrams of the symmetric battery using the bare lithium metal electrode of Comparative Example 2 and the symmetric battery using the lithium metal anode of Example 2 before cycling.

FIG. 22 is the Nyquist diagrams of the symmetric battery using the bare lithium metal electrode of Comparative Example 2 and the symmetric battery using the lithium metal anode of Example 2 after cycling 20 hours.

FIG. 23 is a surface SEM image of the bare lithium metal electrode after the symmetrical battery using the bare lithium metal electrode of Comparative Example 2 cycling for 100 hours.

FIG. 24 is a surface SEM image of the lithium metal anode after the symmetrical battery using the lithium metal anode of Example 2 cycling for 100 hours.

FIG. 25 is a cross-sectional SEM image of the bare lithium metal electrode after the symmetrical battery using the bare lithium metal electrode of Comparative Example 2 cycling for 100 hours.

FIG. 26 is a cross-sectional SEM image of the lithium metal anode after the symmetrical battery using the lithium metal anode of Example 2 cycling for 100 hours.

FIG. 27 is a cycle performance graph of the half-cell containing a bare lithium anode of Comparative Example 3 and the half-cell containing the lithium metal anode of Example 3.

FIG. 28 is a rate performance graph of the half-cell containing the bare lithium anode of Comparative Example 3 and the half-cell containing the lithium metal anode of Example 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

It will be appreciated that for simplicity and clarity of illustration, where appropriate, reference numerals have been repeated among. the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts can be exaggerated to illustrate details and features of the present disclosure better.

Several definitions that apply throughout this disclosure will now be presented.

The term “comprise” or “comprising” when utilized, means “include or including, but not necessarily limited to”; it specifically indicates open-ended inclusion or membership in the so-described combination, group, series, and the like.

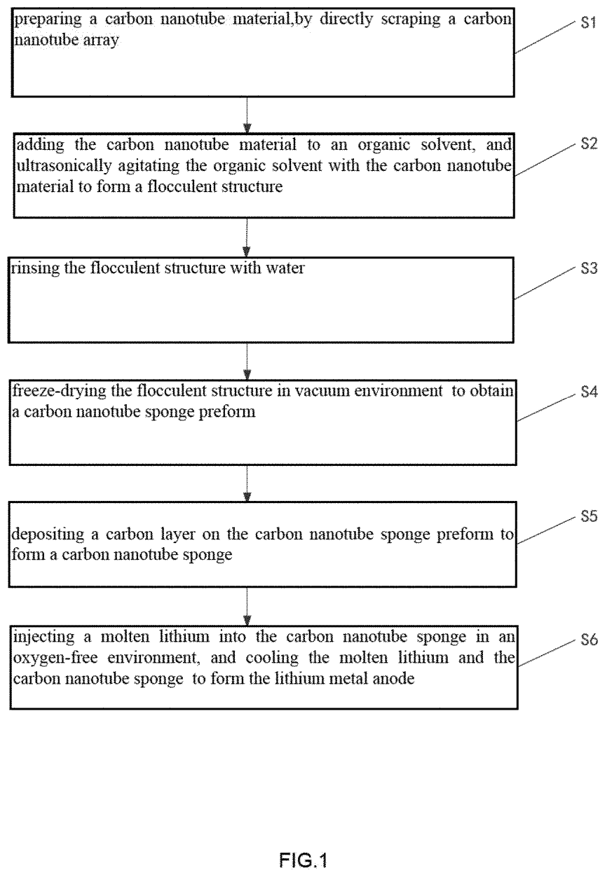

FIG. 1 illustrates a method of one embodiment of making a lithium metal anode, the method comprises:

S1, preparing a carbon nanotube material by directly scraping a carbon nanotube array;

S2, adding. the carbon nanotube material to an organic solvent, and ultrasonically agitating the organic solvent with the carbon nanotube material to form a flocculent structure;

S3, rinsing the flocculent structure with water;

S4, freeze-drying the flocculent structure under in vacuum environment to obtain a carbon nanotube sponge preform;

S5, depositing a carbon layer on the carbon nanotube sponge preform to form a carbon nanotube sponge; and

S6, injecting molten lithium into the carbon nanotube sponge in an oxygen-free environment, and cooling the molten lithium and the carbon nanotube sponge to form the lithium metal anode.

In step S1, the carbon nanotube material consists of carbon nanotubes. The carbon nanotubes can be single-walled carbon nanotubes, double-walled carbon nanotubes, or multi-walled carbon nanotubes. A diameter of the carbon nanotube can be in a range from about 10 nanometers to about 30 nanometers. A length of the carbon nanotubes can be longer than 100 micrometers. In one embodiment, the diameter of the carbon nanotube 122 can be in a range from about 10 nanometers to about 20 nanometers, and the length of the carbon nanotubes is longer than 300 micrometers. The carbon nanotubes can be pure, meaning there are few or no impurities adhered on surface of the carbon nanotubes. A method for making the carbon nanotube material can include providing a carbon nanotube array, wherein the carbon nanotube array can be formed on a substrate, and scratching off the carbon nanotube array from the substrate to form the carbon nanotube material. The carbon nanotube material obtained directly from the carbon nanotube array makes the carbon nanotube sponge stronger. In one embodiment, the carbon nanotube array is a super-aligned carbon nanotube array. In the super-alianed carbon nanotube array, a length of the carbon nanotubes is virtually uniform and is longer than 300 micrometers. Surfaces of the carbon nanotubes are clean and without impurities.

In step S2, the organic solvent has excellent wettability to the carbon nanotubes. The organic solvent can be ethanol, methanol, acetone. isopropanol, dichloroethane, chloroform, or the like. A mass ratio between the carbon nanotube material and the organic solvent can be selected according to actual need.

During a process of ultrasonically agitating the organic solvent having the carbon nanotube material, a power of ultrasonic waves can be in a range from about 300 W to about 1500 W. in some embodiments, the power is in a range from about 500 W to about 1200 W A duration of the process can range from about 10 minutes to about 60 minutes. After the agitation, the carbon nanotubes of the carbon nanotube material are uniformly distributed in the organic solvent, to form the flocculent structure. Since the carbon nanotube material is scratched from the super aligned carbon nanotube array, the process of ultrasonic agitation does not separate the carbon nanotubes, the carbon nanotubes of the carbon nanotube material maintain the flocculent structure. The flocculent structure has a plurality of pores. Since the organic solvent has excellent wettability to the carbon nanotubes, the carbon nanotube material can be uniformly dispersed in the organic solvent. In one embodiment, the carbon nanotube material is added to ethanol and ultrasonically agitated the organic solvent having the carbon nanotube for 30 minutes.

In step S3, a freezing point of the organic solvent is lower than −100 Celsius, which is not appropriate for the subsequent freeze-drying. However, after a process of washing the flocculent structure by water, the plurality of pores of the flocculent structure are filled with water, which is suitable for the subsequent freeze-drying. In one embodiment, deionized water is used to clean the flocculent structure to remove ethanol. so that the pores in the flocculent structure are filled with water.

In step S4, a process of freeze-drying the flocculent structure under a vacuum condition includes steps of:

S41: placing the flocculent structure into a freeze drier, and rapidly cooling the flocculent structure to a temperature lower than −40 Celsius; and

S42: creating a vacuum in the freeze drier and increasing the temperature of the flocculent structure to a room temperature in stages, a time duration of drying in each of the stages ranges from about 1 hour to about 10 hours.

The process of freeze-drying the flocculent structure under a vacuum condition prevents the carbon nanotube sponge preform from collapsing, thus obtaining a fluffy carbon nanotube sponge. A density of the carbon nanotube sponge preform ranges from about 0.5 mg/cm³ to about 100 mg/cm³. The density of the carbon nanotube sponge preform can be changed according to practice. In one embodiment, the carbon nanotube sponge preform is cut into cylinders with a diameter of 16 mm and a density of 10 mg/cm³.

In step S5, a method of depositing the carbon layer on the carbon nanotube sponge preform can be chemical vapor deposition, electrochemical deposition, or any other appropriate method. The chemical vapor deposition includes steps of supplying a carbon source gas to a furnace: heating the furnace at a temperature in the range from about 700 Celsius to about 1230 Celsius with a protective gas therein, to decompose the carbon source gas and form the carbon layer by deposition. The carbon layer uniformly covers a surface of each carbon nanotube, and the carbon layer is connected into a piece at cross between the carbon nanotubes and forms a plurality of micropores. A time of the process of depositing the carbon layer on the carbon nanotube sponge preform ranges from about 1 minute to about 240 minutes. The longer the carbon time, the thicker the carbon layer can be formed on the surface of each carbon nanotube. A thickness of the carbon layer ranges from about 2 nanometers to about 100 nanometers. The carbon layer can be made of crystalline carbon, amorphous carbon, and/or combination thereof. In one embodiment, the carbon nanotube sponge preform is heated in a mixed atmosphere of nitrogen and acetylene at 800° C. for 10 minutes to form an amorphous carbon layer to obtain the carbon nanotube sponge. The thickness of the amorphous carbon layer is 4 nanometers.

In step S6, a lithium sheet is heated to 200° C. to 300° C. to obtain a molten lithium. The molten lithium is a liquid lithium and located on one surface of the carbon nanotube sponge in an oxygen-free atmosphere, so that the molten lithium slowly infuses and infiltrates into the carbon nanotube sponge. In one embodiment, the molten lithium is directly in contact with one surface of the carbon nanotube sponge. The micropores are filled with the molten lithium and the carbon nanotube sponge with molten lithium is cooled. In one embodiment, a pure lithium sheet is heated to 300° C. to obtain the molten lithium, and the molten lithium is located on the surface of the carbon nanotube sponge in a glove box filled with argon gas, so that the molten lithium slowly infuses and infiltrates into micropores of the carbon nanotube sponge. The carbon nanotube sponge with the molten lithium is cooled at room temperature to form the lithium metal anode. The amount of the molten lithium can be selected according to actual needs, for example, it can be selected according to a size of the lithium metal anode. In one embodiment, the amount of molten lithium can cover an entire carbon nanotube sponge. An internal space of the carbon nanotube sponge with a same density or a same mass is basically the same, so the amount of molten lithium infused into the carbon nanotube sponge is also basically the same. In one embodiment, the mass of the molten lithium infused into the carbon nanotube sponge is ranged from about 170 mg to about 180 mg.

In one embodiment, the method of making the lithium metal anode may comprises a step of trimming the lithium metal anode. The lithium metal anode can be cut according to required size. In another embodiment, the method of making the lithium metal anode may comprises a step of a pressing the lithium metal anode to a required thickness. In one embodiment, the lithium metal anode is pressed to a thickness of 600 μm by a rolling mill.

The method of making the lithium metal anode has the following advantages: depositing an amorphous carbon layer on the surface of the carbon nanotube sponge preform, locating the molten lithium in directly contact with the carbon nanotube sponge, and simply heat-injecting the molten lithium into the carbon nanotube sponge to form the lithium metal anode with carbon nanotube sponge. The preparation process of the lithium metal anode is simple and easy to operate. At the same time, the carbon nanotube sponge coated with the amorphous carbon layer shows a stable structure. Amorphous carbon has good lithiophilic and can interact with lithium, thus the molten lithium directly spreads into the micropores of the carbon nanotube sponge to form the lithium metal anode.

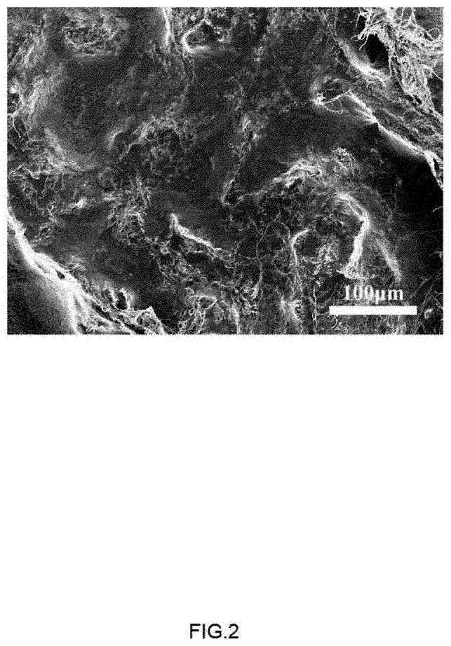

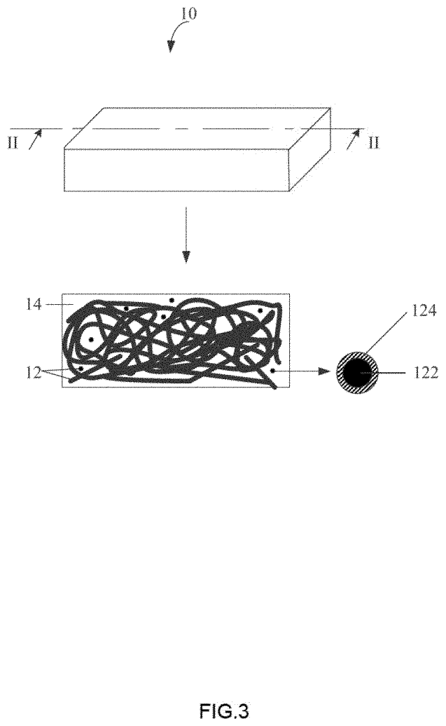

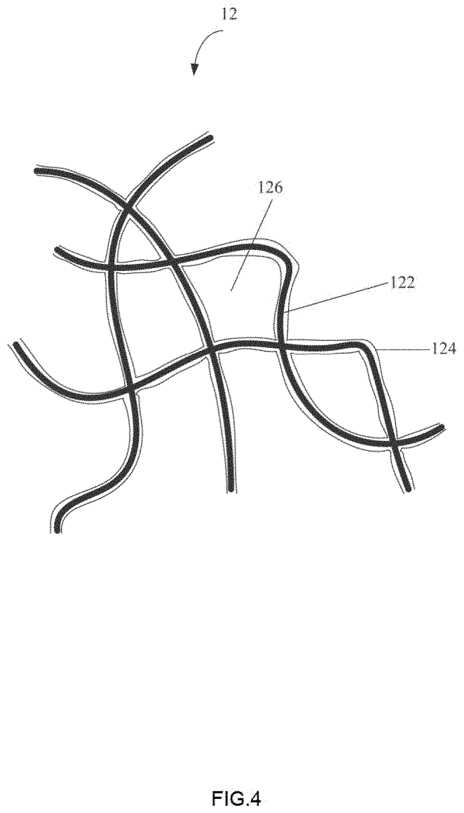

Referring to FIG. 2˜FIG. 4, a lithium metal anode 10 is prepared by the above method. The lithium metal anode 10 comprises a carbon nanotube sponge 12 and a lithium metal material 14. The carbon nanotube sponge 12 comprises a plurality of carbon nanotubes 122 covered by a carbon layer 124 and a plurality of micropores 126. The plurality of micropores 126 are formed by the carbon nanotubes 122 whose surfaces are covered by the carbon layer 124, and the lithium metal material 14 is located in the plurality of micropores 126.

The carbon nanotube sponge 12 comprises a plurality of carbon nanotubes 122. The plurality of carbon nanotubes 122 are entangled with each other to form a carbon nanotube network structure, and a plurality of pores are formed between the plurality of carbon nanotubes 122. The carbon layer 124 uniformly covers a surface of each of the plurality of carbon nanotubes 122, and the carbon layers 124 of two adjacent carbon nanotubes 122 are connected to form a continuous layer at a cross position between the two adjacent carbon nanotubes to form a plurality of micropores 126. The lithium metal material 14 adheres on the surface of the carbon layer 124 and the micropores 126 are filled with the lithium metal material 14. In one embodiment, the lithium metal anode 10 consists of the carbon nanotube sponge 12 and the lithium metal material 14. The carbon nanotube sponge 12 consists of the plurality of carbon nanotubes 122 and the carbon layer 124. The plurality of carbon nanotubes 122 are entangled with each other to form the carbon nanotube network structure, and the plurality of pores are formed between the plurality of entangled carbon nanotubes 122. The carbon layer 124 uniformly covers the surface of each carbon nanotube 122, and the carbon layer 124 is connected to form a continuous layer at a cross position between the carbon nanotubes to form a plurality of micropores 126. The intersection of two adjacent carbon nanotubes 122 forms at least one contact portion, and the contact portion is entirely covered by the carbon layer 124.

The carbon layer 124 does not prevent the carbon nanotubes 122 from being in contact with each other in the at least one contact portion. The lithium metal material 14 covers the surface of the carbon layer 124 and the micropores 126 are filled with the lithium metal material 14.

The lithium metal material 14 is a pure lithium material.

The carbon nanotube 122 can be single-walled carbon nanotubes, double-walled carbon nanotubes, or multi-walled carbon nanotubes. A diameter of the carbon nanotube 122 can be in a range from about 10 nanometers to about 30 nanometers. A length of the carbon nanotube 122 can be longer than 100 micrometers. In one embodiment, the diameter of the carbon nanotube 122 can be in a range from about 10 nanometers to about 20 nanometers, and the length of the carbon nanotubes is longer than 300 micrometers. The carbon nanotubes can be pure, meaning there are few or no impurities adhered on surface of the carbon nanotubes.

The carbon layer 124 may be crystalline carbon, amorphous carbon, and or combination thereof. The thickness of the carbon layer 124 is ranged from about 2 nanometers to about 100 nanometers. In one embodiment, the carbon layer 124 is an amorphous carbon layer, and a thickness of the amorphous carbon layer is 4 nanometers. In the lithium metal anode 10. the mass percentage of carbon nanotubes is ranged from about 6% to about 10%, the mass percentage of the carbon layer is ranged from about 0.5% to about 1%, and the mass percentage of a metallic lithium is ranged from about 85% to about 95%. In one embodiment, in the lithium metal anode 10, the mass percentage of carbon nanotubes is 7.8%, the mass percentage of carbon layer is 0.77%. and the mass percentage of the metallic lithium is 91.43%.

The carbon nanotube 122 coated and covered with the carbon layer 124 may also defines as a carbon nanotube wire. That is, the lithium metal anode 10 comprises a metal lithium block and a plurality of carbon nanotube wires. The plurality of carbon nanotube wires are entangled and in directly contact with each other to form a carbon nanotube wire network structure. The metal lithium block comprises a plurality of gaps, and at least one carbon nanotube wire is located in each of the plurality of gaps. Specifically, where two carbon nanowires intersect each other, the intersection of two adjacent carbon nanotubes 122 forms at least one contact position, and the contact position is entirely covered by the carbon layer 124. The carbon layer 124 does not prevent the carbon nanotubes 122 from directly contacting each other at the contact portion. In one embodiment, each of the plurality of gaps is filled with at least one carbon nanotube wire. The at least one carbon nanotube wire consists of a pure carbon nanotube and the carbon layer.

The lithium metal anode provided by the present invention has the following advantages: the amorphous carbon layer covers the surface of carbon nanotubes and improves the mechanical strength of carbon nanotubes, and separates the carbon nanotubes to prevent the agglomeration of carbon nanotubes in the carbon nanotube sponge. Therefore, the structure of the carbon nanotube sponge is stable, and the carbon nanotube sponge has a plurality of micropores and strong mechanical strength, which is conducive to the recombination of lithium.

The amorphous carbon layer has good lithiophilic, so that the lithium in the lithium metal anode is evenly distributed and filled in the micropores of the carbon nanotube sponge. At the same time, the porous carbon nanotube sponge acts as a stable framework for lithium, provides a strong framework and enough space for lithium deposition/stripping, and reduces a current density along a surface of the lithium metal anode, inhibits a formation of lithium dendrites, and makes the SEI complete and stable, which is beneficial to improve the cycle life of the lithium ion battery.

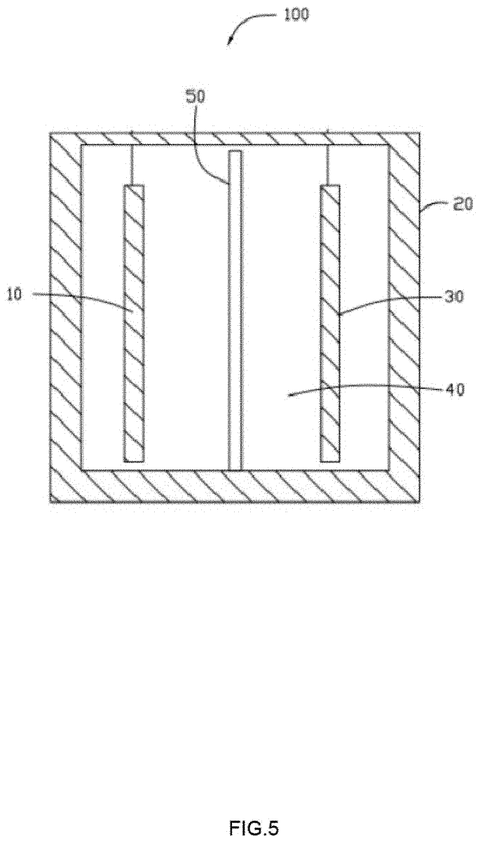

Referring to FIG. 5, a lithium ion battery 100 using the lithium metal anode 10 is provided. The lithium ion battery 100 comprises a casing 20, a lithium metal anode 10, a cathode 30, an electrolyte 40 and a separator 50. The lithium metal anode 10, the cathode 30, the electrolyte 40 and the separator 50 is located in the casing 20. The electrolyte 40 is located in the casing 20, the lithium metal anode 10, the cathode 30 and the separator 50 are located in the electrolyte 40. The separator 50 is located between the lithium metal anode 10 and the cathode 30, and an internal space of the casing 20 is divided into two parts. The lithium metal anode 10 and the separator 50 are space from each other, and the cathode 30 and the separator 50 are space from each other.

The lithium metal anode 10 comprises the carbon nanotube sponge 12 and the lithium metal material 14, and the description of the lithium metal anode 10 will not be repeated here.

The cathode 30 comprises a cathode active material layer and a current collector. The cathode material layer comprises a cathode active material, a conductive agent and a binder. The cathode active material, the conductive agent and the binder are uniformly mixed. The cathode active material can be lithium manganate, lithium cobaltate, lithium nickelate or ithium iron phosphate. The current collector can be a metal sheet, such as a platinum sheet.

The separator 50 may be a polypropylene microporous membrane, the electrolyte salt in the electrolyte 40 may be lithium hexafluorophosphate, lithium tetrafluoroborate or lithium bisoxalate borate, etc., and the organic solvent in the electrolyte 40 may be ethylene carbonate, Diethyl carbonate or dimethyl carbonate, etc. It can be understood that the separator 50 and the electrolyte 40 may also be made of other conventional materials.

### EXAMPLE 1

Providing a super-aligned carbon nanotube array, a diameter of the carbon nanotubes in the carbon nanotube array being about 20 nanometers, and a length of the carbon nanotubes in the carbon nanotube array being about 300 micrometers. Scratching off about 100 mg carbon nanotube array and adding it into 100 ml ethanol and 100 ml deionized water to form a mixture; and agitating the mixture with 400W ultrasonic waves for about 30 minutes, to form a flocculent structure. Washing the flocculent structure by water. Freeze drying the flocculent structure in a freeze drier, and rapidly cooling the flocculent structure to a temperature lower than −30 Celsius for 12 hours. Then increasing the temperature of the flocculent structure to −10 Celsius, creating a vacuum in the freeze drier and drying the flocculent structure for 12 hours, then closing the vacuum system, opening an air inlet valve of the freeze drier, taking out the sample, and obtaining the carbon nanotube sponge preform. Placing the carbon nanotube sponge preform into a reactor, supplying acetylene (The flow rate is 110 sccm) and argon to the reactor; heating the reactor to 800 Celsius, to make the acetylene decompose and form a carbon layer. The carbon layer is deposited on the carbon nanotube sponge preform for about 10 minutes; and finally the carbon nanotube sponge itself is obtained. A weight percentage of the amorphous carbon layer in the carbon nanotube sponge is about 9%, and a thickness of the amorphous carbon layer is 4 nanometers. Heating the pure lithium sheet to 300° C. to obtain a liquid lithium, and filling the glove box with argon gas and locating the liquid lithium on the surface of the carbon nanotube sponge to form a lithium metal anode in the glove box.

### COMPARATIVE EXAMPLE 1

The sample of Comparative Example 1 is the carbon nanotube sponge preform in Example 1.

The properties of the carbon nanotube sponge of Example 1 and the carbon nanotube sponge preform of Comparative Example 1 are compared below.

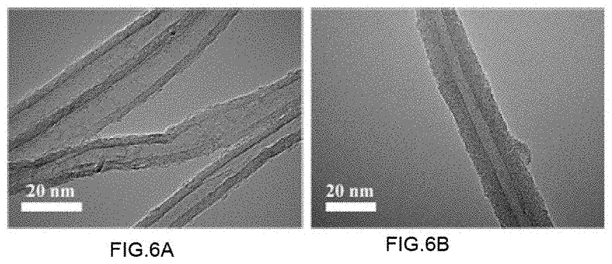

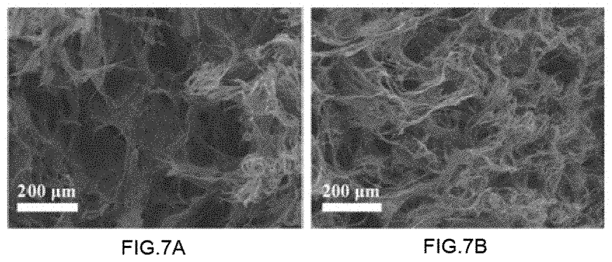

The morphology of the carbon nanotube sponge preform and the carbon nanotube sponge are detected by transmission electron microscope (TEM) and scanning electron microscope (SEM). FIG. 6A is a TEM image of the carbon nanotube sponge preform; FIG. 6B is a TEM image of the carbon nanotube sponge. A thickness of the carbon nanotube wall in the carbon nanotube sponge is 8.5 nm, and a thickness of the carbon nanotube wall in the carbon nanotube sponge preform is 4.5 nm. Since the amorphous carbon layer covers the surface of the carbon nanotube wall in the carbon nanotube sponge, the carbon nanotube wall in the carbon nanotube sponge is thicker than the carbon nanotube wall in the carbon nanotube sponge preform. FIG. 7A is the SEM image of the carbon nanotube sponge preform; FIG. 7B is the SEM image of the carbon nanotube sponge preform. FIG. 7A and FIG. 7B show that the carbon nanotube sponge preform and the carbon nanotube sponge have a 3D porous structure. It can be seen that the amorphous carbon layer does not affect the porous structure of the carbon nanotube sponge.

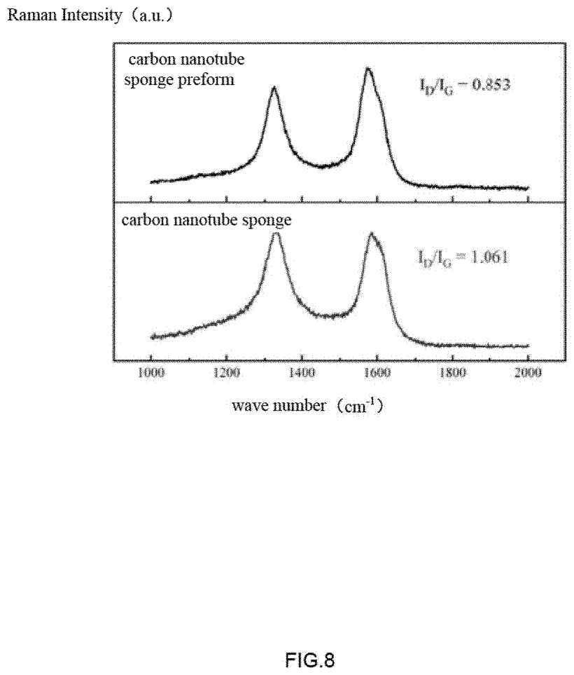

The Raman test is used to further detect the amorphous carbon layer on the carbon nanotube sponge. The Raman spectrum contains two characteristic bands, D band (1374 cm⁻¹) and G band (1580 cm⁻¹), The ratio of the intensity of the D band and the G band (Id/Ig) indicates the defect of carbon nanotubes and the concentration of amorphous carbon. FIG. 8 shows that the Id/Ig ratio of the carbon nanotube sponge preform is 0.853. In the carbon nanotube sponge, a intensity of the D band raises, and the Id/Ig ratio increases to 1.061. Raman spectroscopy shows that amorphous carbon is introduced into the carbon nanotube sponge.

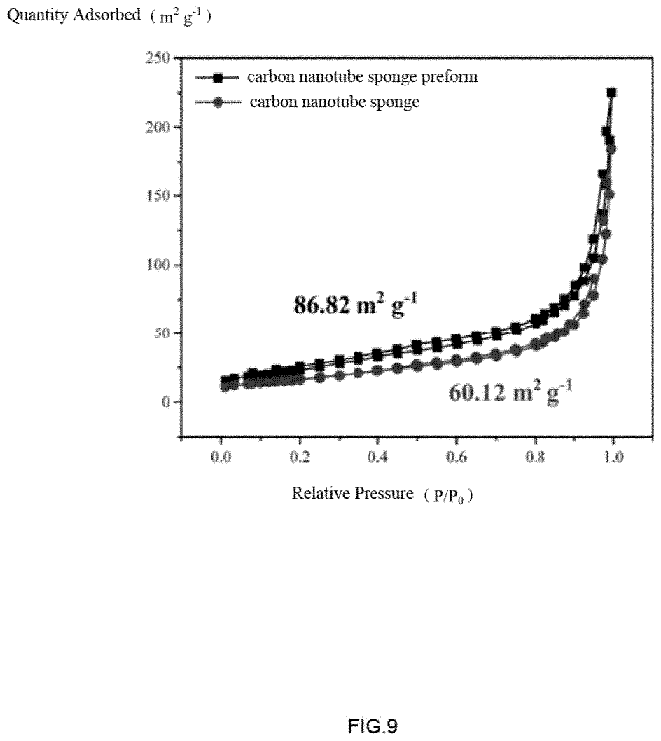

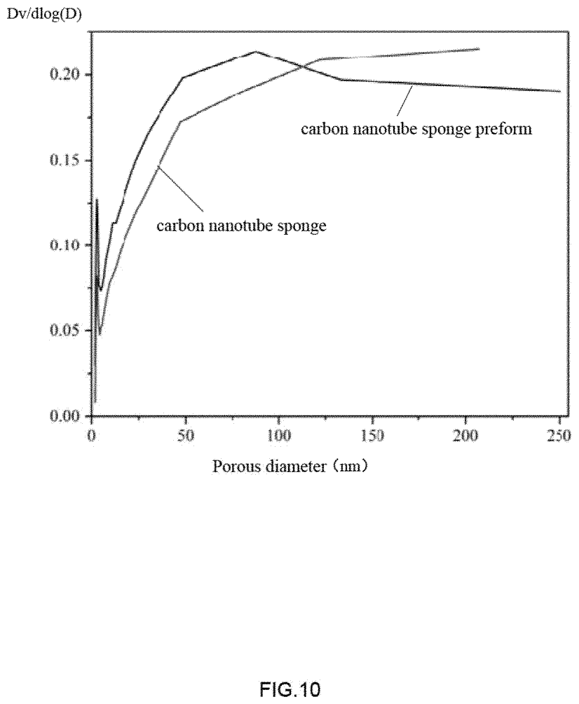

The BET test is used to detect a specific surface area of the carbon nanotube sponge preform and the carbon nanotube sponge. FIG. 9 is a BET side view of a carbon nanotube sponge preform and a carbon nanotube sponge. FIG. 9 shows that the specific surface area of the carbon nanotube sponge is 60.12 m²g⁻¹, and the specific surface area of the carbon nanotube sponge preform is 86.82 m²g⁻¹. FIG. 10 is a pore size distribution diagram of the carbon nanotube sponge preform and the carbon nanotube sponge. As shown in FIG. 10. mesopores and micropores are observed in both the carbon nanotube sponge preform and the carbon nanotube sponge, and the micropores are dominant, indicating that both the carbon nanotube sponge preform and the carbon nanotube sponge have a porous structure. Although the specific surface area and the number of mesopores and micropores of the carbon nanotube sponge are decreased after the introduction of amorphous carbon into the carbon nanotube sponge, the carbon nanotube sponge still exhibits a relatively large surface area and provides enough space for lithium.

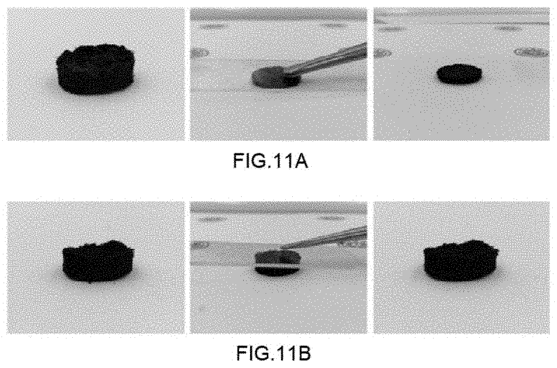

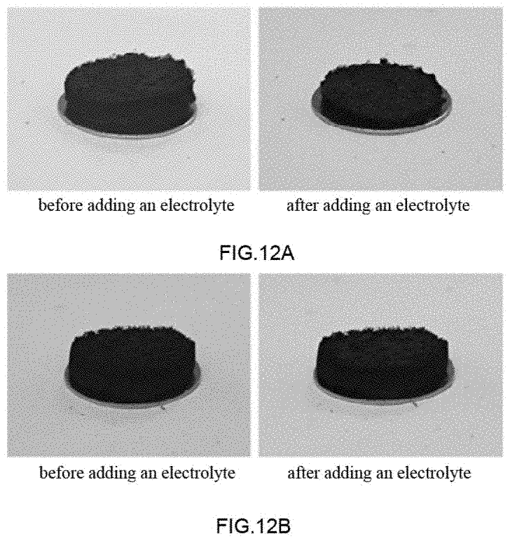

Besides the enough space, a stable structure is also important for lithium metal anode. Therefore, experimental tests are conducted to verify the stable structure of the carbon nanotube sponge. FIG. 11 is a diagram of the pressure test process of the carbon nanotube sponge preform and the carbon nanotube sponge. As shown in FIG 11A and FIG. 11B, pressure is applied to the carbon nanotube sponge preform and the carbon nanotube sponge, both the carbon nanotube sponge preform and the carbon nanotube sponge are pressed into a thin film, and after a few seconds the pressure was removed. The carbon nanotube sponge preform cannot recover and maintain in a thin film state after being pressed, while the carbon nanotube sponge can return to the previous state. FIG. 12 is a comparison diagram of the structure before and after adding electrolyte to the carbon nanotube sponge preform and the carbon nanotube sponge respectively. As shown in FIG. 12A and FIG. 12B, after dropping 200 μl of electrolyte on the carbon nanotube sponge preform and the carbon nanotube sponge respectively, the carbon nanotube sponge keeps fluffy, while the carbon nanotube sponge preform is collapsed after adding electrolyte. The above test confirmed that the carbon nanotube sponge preform becomes more stable after being coated with amorphous carbon. The amorphous carbon Layer covers the surface of the carbon nanotubes and improves the mechanical strength of the carbon nanotubes, and separates the carbon nanotubes to prevent the agglomeration of the carbon nanotubes.

Therefore, the carbon nanotube sponge has a stable structure and strong mechanical strength, which is conducive to the recombination of lithium.

### Lithium Wettability Test of Lithium Metal Anode

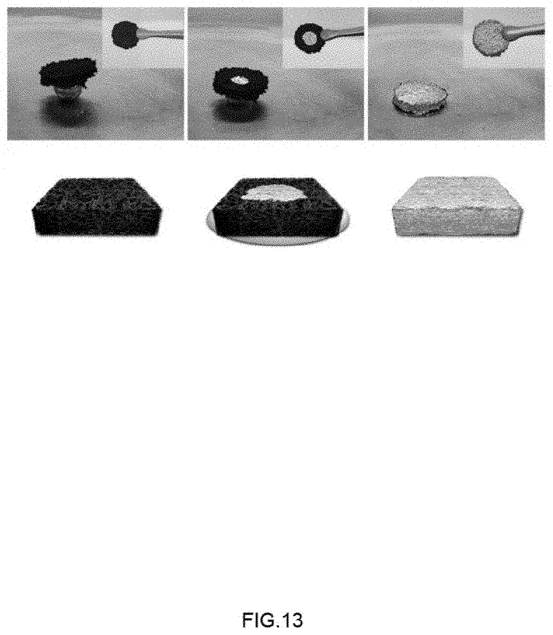

FIG. 13 is a process diagram of molten lithium thermal injection of the carbon nanotube sponge. The carbon nanotube sponge is located on top of the molten lithium, and the molten lithium starts to enter the carbon nanotube sponge from the bottom after 20 minutes. After about another 20 minutes, the molten lithium eventually fill the entire carbon nanotube sponge.

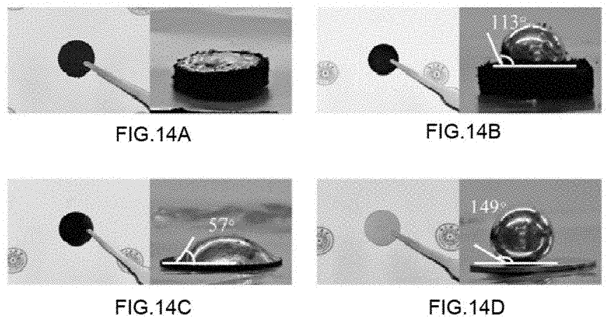

FIG. 14 is a comparison diagram of the lithium wettability test of the carbon nanotube sponge, the carbon nanotube sponge preform, an amorphous carbon coated stainless steel and original stainless steel. FIG. 14A is the lithium wettability test diagram of the carbon nanotube sponge, FIG. 14B is the lithium wettability test diagram of the carbon nanotube sponge preform, FIG. 14C is the lithium wettability test of the amorphous carbon coated stainless steel, and FIG. 14D is the lithium wettability test chart of the original stainless steel. As shown in FIG. 14A-D, the molten lithium is respectively located on the surfaces of the carbon nanotube sponge, the carbon nanotube sponge preform, the amorphous carbon coated stainless steel and the original stainless steel. After 40 minutes, the molten lithium infuses into the carbon nanotube sponge; while the molten lithium can not infuses into the carbon nanotube sponge preform, and kept the state of spherical lithium beads with a contact angle 113°, which indicates that the lithiophilicity of the carbon nanotube sponge preform is poor. The molten lithium on stainless steel is also spherical lithium beads, and the contact angle of the molten lithium on the original stainless steel is 149°. After the original stainless steel is modified with amorphous carbon, the contact angle between the molten lithium and the amorphous carbon coated stainless steel is 57 indicating that the amorphous carbon can improve the wettability of lithium.

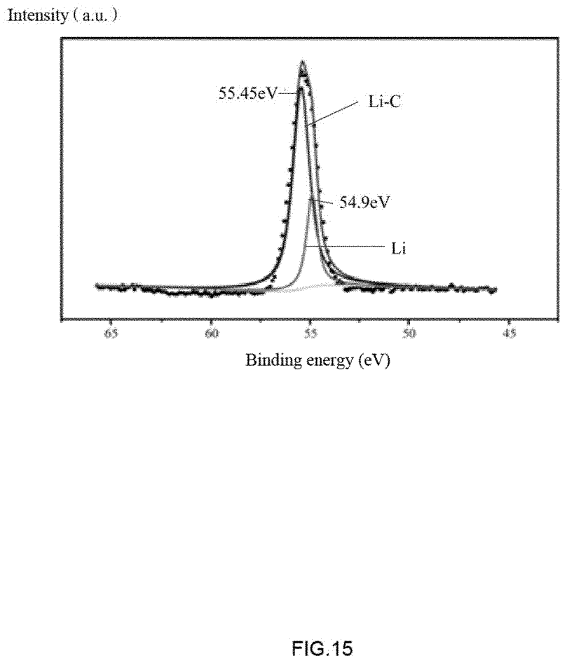

In order to further understand the connection between lithium and amorphous carbon, the lithium metal anode was tested by XPS. FIG. 15 shows the XPS spectrum of the lithium metal anode. As shown in FIG. 15, there is a Li—C peak at 55.45 ev, indicating the chemical reaction between the lithium and the amorphous carbon at high temperature. In the preparation process of the lithium metal anode, the molten lithium reacts with the amorphous carbon on the surface first, and a product of the reaction is lithiophilic. Therefore, the molten lithium is slowly injected into the carbon nanotube sponge and reacts with the internal amorphous carbon, and finally the molten lithium spread to the whole carbon nanotube sponge.

### EXAMPLE 2

A symmetrical battery of Example 2 is assembled in a glove box under an argon atmosphere. A working electrode and a counter electrode of the symmetrical battery both are lithium metal anodes. 1M LiPF6 with 2 wt% VC in EC:DMC:DEC (1:1:1 by volume) is used as the electrolyte.

### COMPARATIVE EXAMPLE 2

A structure of the symmetrical battery of Comparative Example 2 is basically the same as that of the symmetrical battery of Example 2, except that the working electrode and the counter electrode of the symmetrical battery are bare pure metal lithium sheets, hereinafter referred to as bare lithium metal electrodes.

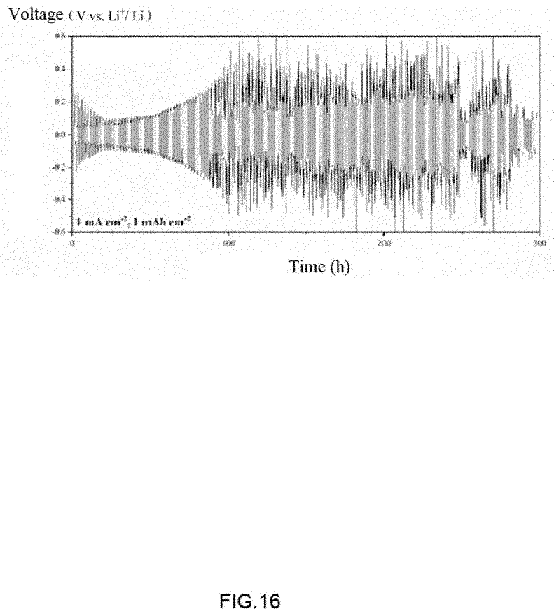

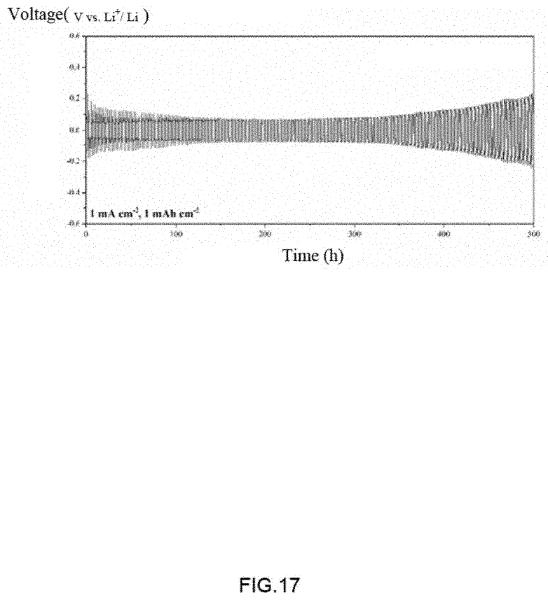

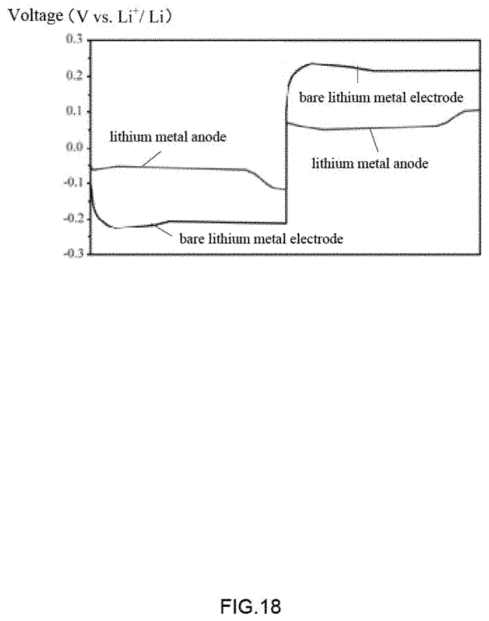

A constant current cycle measurement in symmetrical batteries is conducted to evaluate the electrochemical performance of the bare lithium metal electrode and the lithium metal anode. FIG. 16 is a voltage-time graph of the symmetrical battery using the bare lithium metal electrode. FIG. 17 is a voltage-time graph of the symmetrical battery using the lithium metal anode. In FIG. 16 and FIG. 17, the symmetrical battery using the bare lithium metal electrode and the symmetrical battery using the lithium metal anode are cycled at a fixed current density of 1 mAcm⁻² and a deposition/stripping capacity of 1 mAhcm². FIG. 18 is a graph of the voltage-time curve of the symmetrical battery using the bare lithium metal electrode and the symmetrical battery using the lithium metal anode during a cycle time of 78-80 hours. As shown in FIG. 16-18, for the symmetrical battery using the lithium metal anode, the voltage hysteresis are lower than 0.2 V and are remained unchanged during the whole cycle of 500 hours. However, for the symmetrical using the bare lithium metal electrode, a gradual voltage hysteresis increases with increasing cycle time, and the voltage hysteresis fluctuates irregularly after a cycle time of 90 hours, and a voltage suddenly drops at a cycle time of 250 hours. A fluctuating voltage in symmetric batteries using the bare lithium metal electrode can be explained by uneven lithium deposition and unstable SE1, and the sudden drop can be attributed to internal short circuits with Li dendrite penetration. It can be seen from the above comparison that the lithium metal anode effectively reduces the voltage hysteresis of the symmetric battery and stabilizes the cycle performance of the symmetric battery.

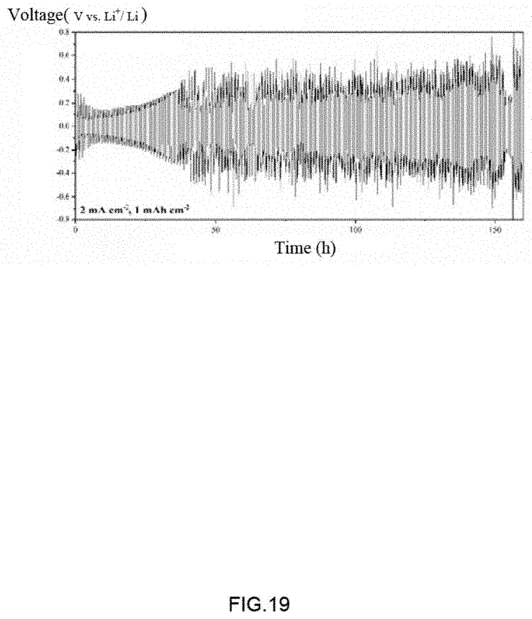

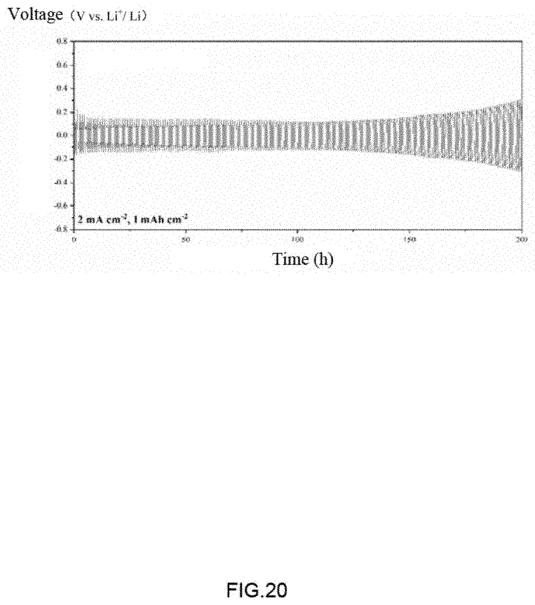

FIG. 19 is a voltage-time graph of a symmetrical battery using the bare lithium metal electrode. FIG. 20 is a voltage-time graph of a symmetrical battery using the lithium metal anode. In FIG. 19 and FIG. 20, the cycle performance of a symmetric battery using the bare lithium metal electrode and a symmetric battery using the lithium metal anode is tested under a fixed current density of 2 mAcm⁻² and a deposition/stripping capacity of 1 mAhcm². As shown in FIG. 19 and FIG. 20, when the current density is increased to 2 mAcm⁻², the lithium metal anode still effectively lowers the voltage hysteresis, stabilizes the cycle performance, and extends the battery lifetime.

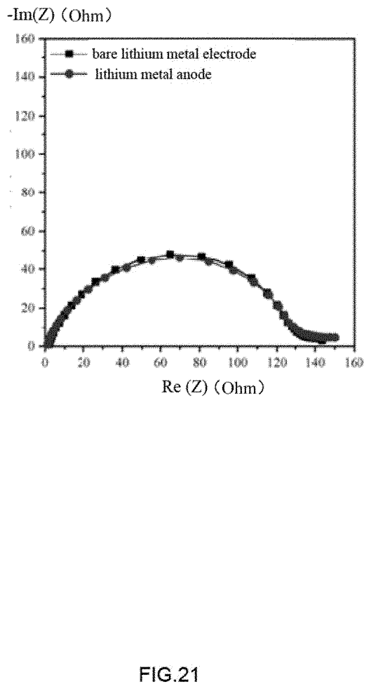

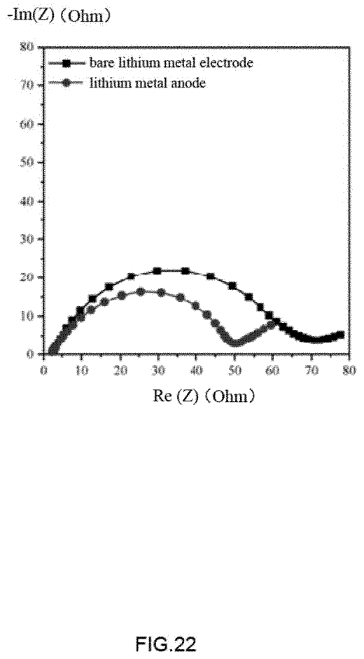

FIG. 21 is a Nyquist diagram before cycling of the symmetric battery using the bare lithium metal electrode and the symmetric battery using the lithium metal anode. FIG. 22 shows the Nyquist diagram of the symmetric battery using the bare lithium metal electrode and the symmetric battery using the lithium metal anode after cycling for 20 hours. In FIG. 21 and FIG. 22, cycling performances differences of the symmetric battery using the bare lithium metal electrode and the symmetric battery using the lithium metal anode are further testified by EIS analysis before cycling and after 10 cycles at a deposition/striping capacity of 1 mAh cm⁻². For symmetrical batteries, the semicircle at the high frequency range is an indicator of the interfacial resistance at the SEI and the charge transfer resistance at the lithium surface. Before cycling, the symmetric battery using the bare lithium metal electrode and the symmetric battery using the lithium metal anode showed similar interfacial resistance, indicating a similar interface. After 10 cycles, the symmetric battery using the lithium metal anode shows smaller impedance than the symmetric battery using the bare lithium metal electrode. The smaller impedance indicates that the lithium metal anode has better electrode stability and lithium deposition/exfoliation kinetics, which is in accordance with a stable voltage-time profiles in the symmetric battery with a lithium metal anode.

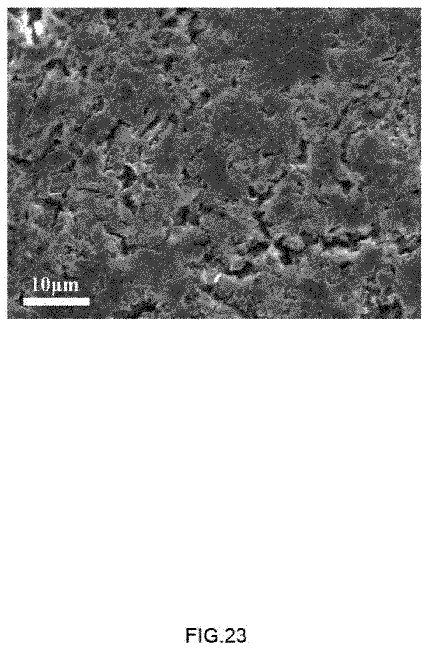

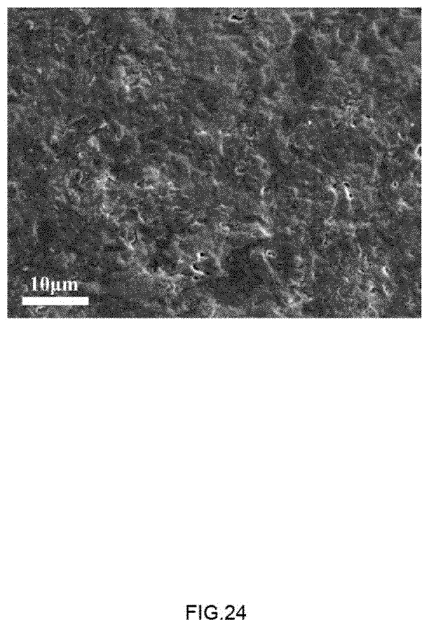

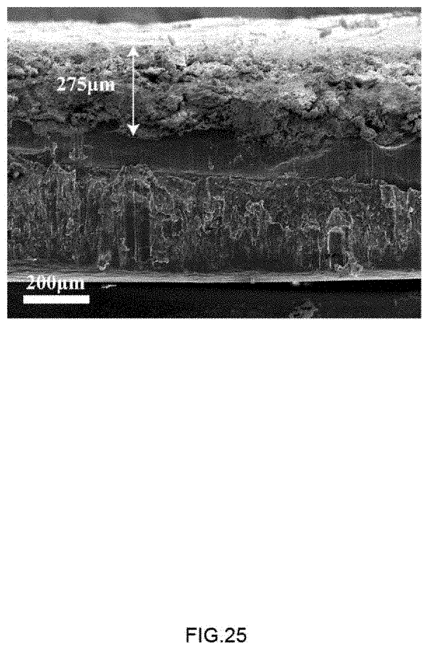

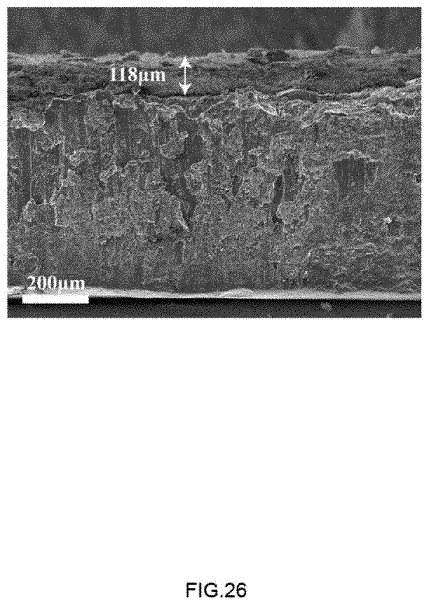

FIG. 23 is a surface SEM image of the bare lithium metal electrode after the symmetric battery using the bare lithium metal electrode is cycled for 100 hours. FIG. 24 is a surface SEM image of the lithium metal anode after the symmetric battery using the lithium metal anode is cycled for 100 hours. FIG. 25 is a cross-section SEM image of the bare lithium metal electrode after the symmetrical battery using the bare lithium metal electrode is cycled for 100 hours. FIG. 26 is a cross-section SEM image of the lithium metal anode after the symmetric battery using the lithium metal anode is cycled for 100 hours. In FIG. 23 to FIG. 26, the symmetric battery using the bare lithium metal electrode and the symmetric battery using the lithium metal anode are cycled under the deposition/exfoliation capacity of 1 mAh cm⁻² respectively. As shown in FIG. 23, the surface of the bare lithium metal electrode is rough, and there are with random cracks and uneven lithium islands in the surface of the bare lithium metal electrode. As shown in FIG. 24, the surface of the lithium metal anode is relatively flat with several small holes.

As shown in FIG. 25, the volume of the bare lithium metal electrode changes greatly, and a 275 μm thick layer of “bare lithium” is observed on the top of the bare lithium metal electrode. As shown in FIG. 26, the volume change of the lithium metal anode is smaller, and the layer of “dead lithium” is thinner (118 μm) and compact. The loose and unstable structure of the bare lithium metal electrode is due to the unstable SEI and lithium dendrites. Uneven lithium deposition/exfoliation of the bare lithium metal electrode lead to lithium dendrites, and lithium dendrites can penetrate the unstable SEI, causing random cracks and uneven surface. The electrolyte passes through the SEI through the cracks and reacts with fresh lithium to form a new SEI. However, the new SEI is also unstable. The electrolyte is consumed, the SEI is formed and broken repeatedly, and long lithium dendrites are detached from the bare lithium metal electrode, resulting in a thick layer of “dead lithium”, a loose structure and battery failure. As the matrix of the lithium metal anode, the porous carbon nanotube sponge in the lithium metal anode acts as a stable skeleton for lithium to reversibly deposit/strip, and reduces local current density along the surface of the lithium metal anode. Therefore, the lithium can be deposited uniformly, the formation of lithium dendrites is suppressed, and the SEI is intact and stable.

### EXAMPLE 3

A lithium cobalt oxide electrode slurry is prepared by mixing lithium cobalt oxide, super-P acetylene black and poly(vinylidene fluoride) in N-methylpyrrolidone (NMP). A weight ratio of lithium cobalt oxide, super-P acetylene black and poly(vinylidene fluoride) is 8:1:1. Then the lithium cobalt oxide electrode slurry is uniformly pasted on an aluminum sheet to form a lithium cobalt oxide electrode. The lithium cobalt oxide electrode is used as the cathode, and the lithium metal anode is used as the anode. 1M LiPF6 with 2 wt % VC in EC:DMC:DEC (1:1:1 by volume) is used as the electrolyte to form a half-cell. In example 3, after the lithium cobalt oxide electrode is dried at 120° C. for 24 hours, the lithium cobalt oxide electrode is cut into a circle with a diameter of 10 mm, and an area density of the lithium cobalt oxide electrode is 10 mg cm ². A size of the lithium metal anode corresponds to a size of the lithium cobalt oxide electrode.

### COMPARATIVE EXAMPLE 3

The structure of the half-cell of Comparative Example 3 is basically the same as the structure of the half-cell of Example 3. The difference is that the anode of the half-cell is a bare pure metal lithium sheet, hereinafter referred to as a bare lithium anode.

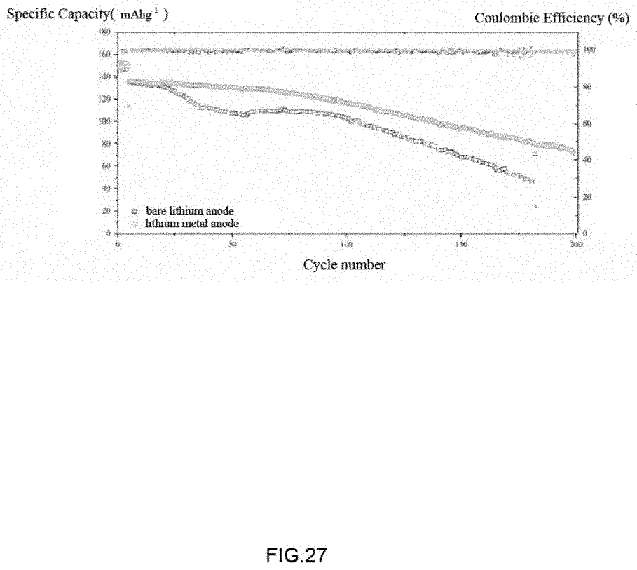

The half-cell constant current cycle measurement is performed on the half-cells of Example 3 and Comparative Example 3 by Land Battery System, and the cut-off voltage is 3 V −4.3V. FIG. 27 is a cycle performance graph of a half-cell containing a bare lithium anode and a half-cell containing a lithium metal anode. As shown in FIG. 27, the half-cell containing the bare lithium anode and the half-cell containing the lithium metal anode are cycled 3 times at 0.1C first and cycled at 1C afterwards. When cycling 3 times at 0.1C, the specific capacity of the half-cell containing the lithium metal anode is 152 mAhg⁻¹, and the specific capacity of the half-cell containing the bare lithium anode is 145.1 mAhg⁻¹. The half-cell containing the lithium metal anode shows 71 mAhg after 200 cycles at 1C with coulombic efficiency 99.3%; and the half-cell containing the bare lithium anode fails after 182 cycles. After the half-cell containing the bare lithium anode fails, the cell is take apart, and then the bare lithium anode is replaced with a new bare lithium anode to assemble a new half-cell.

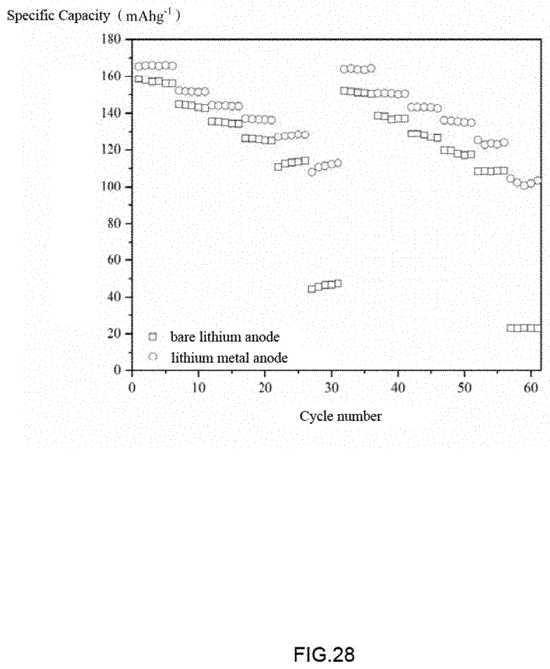

FIG. 28 is a rate performance graph of the half-cell containing the bare lithium anode and the half-cell containing the lithium metal anode. As shown in FIG. 28, the specific capacities of the half-cell containing the lithium metal anode at 0.1 C, 0.2 C, 0.5 C, 1 C, 2 C and 5 C are 165.4 mAh g ⁻¹, 152.1 mAh g⁻¹, and 144.3 mAh g⁻¹, 137 mAh g⁻¹, 126.9 mAh g⁻¹ and 108 mAh g⁻¹ respectively. In contrast, the specific capacities of the cell containing the bare lithium metal anode at 0.1-5 C are lower. When the cycling rate drops back to 0.1C, the capacity of the half-cell containing the bare lithium anode is 152 mAh g⁻¹, while the capacity of the half-cell containing the lithium metal anode is 164 mAh g⁻¹. It can be seen that the half-cell containing the lithium metal anode has better half-cell constant current performance, which proves its potential for practical lithium metal batteries.

Even though numerous characteristics and advantages of certain inventive embodiments have been set out in the foregoing description, together with details of the structures and functions of the embodiments, the disclosure is illustrative only. Changes can be made in detail, especially in matters of an arrangement of parts, within the principles of the present disclosure to the full extent indicated by the broad general meaning of the terms in which the appended claims are expressed.

Depending on the embodiment, certain of the steps of methods described can be removed, others can be added, and the sequence of steps can be altered. It is also to be understood that the description and the claims drawn to a method can comprise some indication in reference to certain steps. However, the indication used is only to be viewed for identification purposes and not as a suggestion as to an order for the steps.

The embodiments shown and described above are only examples. Even though numerous characteristics and advantages of the present technology have been set forth in the foregoing description, together with details of the structure and function of the present disclosure, the disclosure is illustrative only, and changes can be made in the detail, especially in matters of shape, size and arrangement of the parts within the principles of the present disclosure up to, and including the full extent established by the broad general meaning of the terms used in the claims. It will, therefore, be appreciated that the embodiments described above can be modified within the scope of the claims.

What is claimed is:

1. A method of making a lithium metal anode, comprises:
S1, preparing a carbon nanotube material by directly scraping a carbon nanotube array;
S2, adding the carbon nanotube material to an organic solvent, and ultrasonically agitating the organic solvent with the carbon nanotube material to form a flocculent structure;
S3, rinsing the flocculent structure with water;
S4, freeze-drying the flocculent structure in a vacuum environment to obtain a carbon nanotube sponge preform;
S5, depositing a carbon layer on the carbon nanotube sponge preform to form a carbon nanotube sponge; and
S6, injecting molten lithium into the carbon nanotube sponge in an oxygen-free environment, and cooling the molten lithium and the carbon nanotube sponge to form a lithium metal anode.

2. The method of claim 1 further comprising heating a lithium sheet to a temperature ranged from about 200° C. to about 300° C. to form the molten lithium in S6.

3. The method of claim 1, wherein in S6, the molten lithium is located on surfaces of the carbon nanotube sponge in an enclosed environment filled with argon gas, and the molten lithium infuses into micropores in the carbon nanotube sponge.

4. The method of claim 1 further comprising cooling the carbon nanotube sponge with the molten lithium therein within to room temperature to form the lithium metal anode.

5. The method of claim 1, wherein the carbon nanotube material consists of a plurality of carbon nanotubes.

6. The method of claim 5, wherein an average length of the plurality of carbon nanotubes is longer than 300 micrometers.

7. The method of claim 1, wherein the organic solvent is ethanol, methanol, acetone, isopropanol, dichloroethane or chloroform.

8. The method of claim 1, wherein in S4, a process of freeze-drying the flocculent structure in a vacuum environment comprises sub-steps of:
placing the flocculent structure into a freeze drier, and cooling the flocculent structure to a temperature lower than −40 Celsius; and
creating a vacuum in the freeze drier and increasing a temperature of the flocculent structure to a room temperature in stages, wherein a time duration of drying in each of the stages ranges from about 1 hour to about 10 hours.

9. The method of claim 1, wherein a density of the carbon nanotube sponge preform ranges from about 0.5 mg/cm³ to about 100 mg/cm³.

10. The method of claim 1, wherein the carbon layer is deposited on the carbon nanotube sponge preform by chemical vapor deposition or electrochemical deposition.

11. A lithium metal anode comprising:
a carbon nanotube sponge comprising a plurality of carbon nanotubes and a carbon layer, wherein the plurality of carbon nanotubes are entangled with each other to form a carbon nanotube network structure comprising micropores, and the carbon layer is on surfaces of the plurality of carbon nanotubes; and
a lithium material in the micropores.

12. The lithium metal anode of claim 11, wherein junctions between crossing carbon nanotubes of the plurality of carbon nanotubes are covered by the carbon layer.

13. The lithium metal anode of claim 11, wherein the micropores of the carbon nanotube sponge are filled with the lithium material.

14. The lithium metal anode of claim 11, wherein intersections of two adjacent carbon nanotubes form contact portions, and each of the contact portions is entirely covered by the carbon layer.

15. The lithium metal anode of claim 11, wherein a length of each of the plurality of carbon nanotubes is longer than 300 micrometers.

16. The lithium metal anode of claim 11, wherein a mass percentage of the plurality of carbon nanotubes is ranged from 6% to 10%, a mass percentage of the carbon layer is ranged from 0.5% to 1%, and a mass percentage of the lithium material is ranged from 85% to 95% in the lithium metal anode.

17. A lithium metal anode comprising:
a plurality of carbon nanotube wires, wherein each of the plurality of carbon nanotube wires comprises a carbon nanotube and a carbon layer, the carbon layer coats and covers surfaces of the carbon nanotube; and
a lithium block defining a plurality of gaps, wherein at least one carbon nanotube wire is located in each of the plurality of gaps.

18. The lithium metal anode of claim 17, wherein intersections of two adjacent carbon nanotubes form at least one contact portion, and the at least one contact portion is entirely covered by the carbon layer.

19. The lithium metal anode of claim 17, wherein each of the plurality of gaps is filled with at least one carbon nanotube wires of the plurality of carbon nanotube wires.

20. The lithium metal anode of claim 17, wherein a length of each of the carbon nanotube is longer than 300 micrometers.
